(19) United States
(12) Patent Application Publication
(10) Pub. No.: US 2009/0147988 A1
(43) Pub. Date: Jun. 11, 2009

(54) IMAGE TRANSFER WITH SECURE QUALITY ASSESSMENT

(76) Inventors: Paul W. Jones, Churchville, NY (US); Chris W. Honsinger, Ontario, NY (US); Robert J. McComb, Mississauga (CA)

Correspondence Address: LOUIS S. HORVATH, PLS, 252 Plymouth Ave. South, ROCHESTER, NY, 14608, US

(21) Appl. No.: 12/326,128

(22) Filed: Dec. 2, 2008

Related U.S. Application Data
(60) Provisional application No. 60/992,339, filed on Dec. 5, 2007.
(60) Provisional application No. 61/026,526, filed on Feb. 6, 2008.

(51) Int. Cl. G06K 9/00

(52) U.S. Cl. 382/100

(57) ABSTRACT

A method for producing an assured image from image data that is transferred from a first entity to a second entity acquires image data, transfers the acquired image data from the first entity to the second entity, forms secure assurance data according to image quality measurements obtained from the acquired image data, and forms an assured image that includes the acquired image data and the secure assurance data. At least one image quality message is generated that indicates the transfer of the acquired image data from the first entity to the second entity and is representative of the image quality measurements. The at least one image quality message is presented to at least one of the first entity and the second entity.

### CROSS-REFERENCE TO RELATED APPLICATIONS

Reference is made to, and priority is claimed from, U.S. Ser. No. 60/992,339, filed as a Provisional Patent Application on Dec. 5, 2007, entitled “IMAGE TRANSFER WITH SECURE QUALITY ASSESSMENT”, in the names of Paul W. Jones et al. and commonly assigned, and to. U.S. Ser. No. 61/026,526, filed as a Provisional Patent Application on Feb. 6, 2008, entitled “IMAGE TRANSFER WITH SECURE QUALITY ASSESSMENT”, in the names of Paul W. Jones et al. and commonly assigned

Reference is also made to commonly assigned application Ser. No. 11/454673, filed May 16, 2006 and entitled “Assured Document and Method of Making” by Robert J. McComb, and to commonly assigned application Ser. No. 11/940347, filed Nov. 15, 2007 and entitled “Method for Making an Assured Image” by Chris W. Honsinger, Paul W. Jones, and Robert J. McComb.

### FIELD OF THE INVENTION

The invention relates generally to data integrity in digital image processing, and in particular to a method for assessing and certifying the quality of digital image data that has been transferred between two entities, securing the integrity of the quality certification and the digital image data, and providing feedback to at least one entity on the quality of the transferred image data.

### BACKGROUND OF THE INVENTION

The exchange of image information in electronic form has become essential in today's society. Image data that is produced from scanned documents is routinely transferred between corporations, institutions, government agencies, and individuals to facilitate and expedite the transfer of legal contracts, loan applications, insurance forms, purchase orders, medical records, police records, business reports, and bank checks and other financial instruments, to name just a few possible uses. The transfer of image data that is produced by digital cameras has also become commonplace in many aspects of business and government, with diverse applications that include identification photographs, insurance claims, facility and employee surveillance, and legal evidence, for example. The transfer of digital image data can be accomplished using various communication channels, including telephone lines, internet connections, dedicated networks, and wireless transmitters and receivers.

The imaging devices that are used to acquire digital image data include, for example, fax machines, flatbed scanners, high-speed document scanners, digital still cameras, digital video cameras, and cell phone cameras. The nature of the image data varies with the acquisition device and the application, ranging from fax machines that produce bi-tonal (one-bit) images at 100 dpi (850×1100 pixels for an 8½″×11″ document) to large format digital cameras that produce full color images with 48 bits/pixel (16 bits/color) at resolutions of 10,000×12,000 pixels or more.

Regardless of the particular technologies that are used to acquire and transfer digital image data, there is a need for the image data to represent the original medium, where the medium is a document or any other physical object or scene, with sufficient fidelity for the intended application. For example, a document that is intended to be read by a person is not useful if it is illegible. Similarly, an identification photograph that is out of focus may be of limited value as a security tool.

Assessment of image quality is important for both the sender and the receiver of image data. For example, a person who faxes a loan application and supporting documents (such as a paycheck stub as proof of income) wants to know that the fax image data was received by the loan company and that the image quality of the documents was sufficient for the loan process to proceed. Likewise, the loan company wants to know that the quality of the received documents was sufficient for all necessary information to be extracted from the documents, whether the information extraction is performed by a human being or by a computer. As another example, an insurance claims adjuster who sends digital images of a damaged house to a central claims processing facility wants to know that the images were received and that they have sufficient quality before the claims adjuster leaves the site. The central claims facility also wants to know that the received image have sufficient quality to act as supporting evidence of the damage, which could be particularly important if an insured party sues over the amount that was paid on the claim.

Image quality can be assessed in a variety of ways, using both human observers and computer analysis. There are tradeoffs among the various methods in terms of speed, cost, and reliability, and a given application may use more than one method to achieve a desired balance of these factors.

One approach to assessing image quality is to have a human being visually inspect each image. However, if there are large numbers of images, this approach may not be economically feasible and a human being may also be prone to fatigue and errors.

Another approach to assessing image quality is to use test targets. A test target acts as a reference image, and quality metrics calculated from that reference can provide an assessment of actual versus ideal performance for a capture device. Image quality attributes that are measured from a test target can include, for example, resolution, sharpness, dynamic range, noise, and color reproduction. Quality measurements using known test targets are termed “full-reference” measurements. Test targets are often used on an intermittent basis during the operation of an image capture device to determine if the device is performing as expected.

A third approach is to assess image quality directly from the captured image data itself, without the use of test targets. When the only information that is available to assess quality is the image data, which generally has unknown characteristics, the quality measurement techniques are referred to as “no-reference” methods. An example of a no-reference image quality metric is described in a technical paper entitled “A no-reference perceptual blur metric” by P. Marziliano, F. Dufaux, S. Winkler, and T. Ebrahimi, Proceedings of the IEEE International Conference on Image Processing, Vol. III, pp. 57-60, September 2002. The method in this paper computes a blur metric (that is, a loss in sharpness) by identifying vertical edges in an image and then determining the average spatial extent of the edges. The Financial Services Technology Consortium (FSTC), which is a consortium of banks, financial services providers, academic institutions, and government agencies, has investigated a similar no-reference blur metric for Check 21 applications, where bank checks are scanned and the digital check images are sent rather than the original paper documents. The FSTC has also investigated a number of other no-reference quality metrics for Check 21 applications, including compressed image file size, document skew angle, and number of black pixels (for a bi-tonal image). These Check 21 quality metrics are primarily quality measures that indicate whether or not certain defects are present such as “image too light”, “image too dark”, “excessive document skew”, and “horizontal streaks present in the image”. A full description of the FSTC quality metrics can be found at Internet address www.fstc.org/docs/prm/FSTC_Image_Defect_Metrics.pdf.

The sensitive nature of the image information in many applications makes it necessary to ensure that the image data is not tampered with after it is produced. It is a simple matter to change the contents of a digital image by using an image editor or other readily available computer technology. One approach to ensuring data integrity is to use encryption. Encryption has the benefit that the image data may be completely protected against unauthorized viewing, which is important if the image data represents private or sensitive information. However, encryption can be computationally expensive for large amounts of data, such as is the case for high resolution images and video sequences.

As a result, a more practical approach to ensuring the integrity of a digital data file is to use a digital signature. Digital signatures are based on the concept of a hash. A hash is a relatively short numerical value that represents a distilled version of the larger digital data file. Methods that perform this distillation are referred to as hash functions or hash algorithms, and hash functions are designed so that a small change in the digital data file will produce a significant change in the calculated hash value. A digital signature is an encrypted version of the hash, and the digital signature is associated with the digital file in some way, such as attaching it to the file header or storing in a database that is indexed by a unique identifier. An image that has been associated with a digital signature in the manner just described is often called a “secure” image. Tampering with the digital data can be detected by recalculating the hash and comparing it to the original hash in the secure digital signature. A benefit of securing images with digital signatures is that the image data itself is in the “clear”, that is, unencrypted, which means a secure image can be used like any other image, yet its integrity can be verified at any time.

In addition to securing the image data, it is also desirable to have the image quality measures secured against possible tampering. One reason for securing the quality measures is that they may have an economic value associated with their use. For example, in a Check 21 environment, the image quality metrics can affect the workflow of the electronic check data. For example, a poor quality image may require special handling, which incurs extra costs. A bank that receives a poor quality check image might require the originating bank to rescan the check, or the receiving bank might simply assume liability for the cost of the check if it is a small dollar amount. The result is an increase in service costs and delays in completing the clearance of checks, as well as the potential loss of good will with customers. Another reason for secure quality measures is that it may be desirable to quickly evaluate the image quality at various points in the lifecycle of a digital image, without having to perform another visual inspection or computer analysis of the image data. This capability can be achieved by assessing image quality once and then securing the quality metrics against tampering. Still another reason is that a quality assessment process with secure quality measures provides evidence of due diligence for both the sender and the receiver of image data, which can reduce liability risk if the acceptance, handling, or use of image data is ever called into legal question.

Furthermore, it is desirable to link the secure image quality measures and the secure image data, so that any change in the image data renders the associated quality metrics as invalid. Current applications that assess image quality, such as Check 21 processing systems, do not secure the image quality metrics and hence are susceptible to tampering of the quality data, which may result in an inefficient workflow and financial losses. It is easy to imagine that a digital scan of a check may be vulnerable to courtroom challenge on the basis of poor image quality, despite the use of digital signatures for the image data itself by the bank.

In a commonly assigned co-pending U.S. patent application entitled “Assured document and method of making” by Robert J. McComb, filed 16 May 2006, a method is taught for measuring the scanned image quality of documents using test targets and for securing the image quality measurements in combination with secure image data. The document images that are produced by this method are termed “assured documents”. Image quality metrics are calculated from test targets that are periodically inserted into a document queue, and these metrics are associated with the scanned image data for user documents that are in the same document queue. If the quality metrics meet predetermined quality specifications, the quality metrics are associated with the image data of an individual user document by combining the quality metrics with a hash value of the image data, followed by encryption of the combined quality metrics and hash value to form secure assurance data. The secure assurance data, comprised of the encrypted quality metrics and image hash value, is stored in the file header or filename of the digital document, or by other means, as disclosed in the co-pending application by McComb, to produce an assured document. If the quality metrics do not meet predetermined quality specifications, an assured document is not produced.

In a commonly assigned co-pending U.S. patent application entitled “Method for making an assured image” by Chris W. Honsinger, Paul W. Jones, and Robert J. McComb, filed 15 Nov. 2007, improvements are taught for the method by McComb. One improvement is the use of no-reference quality metrics, as described previously, which reduces or eliminates the need for test targets to assess image quality. This is advantageous in applications where test targets are not readily available, economically viable, or otherwise usable. Another improvement in the method by Honsinger et al. is the concept of an “assured document” is extended to provide for an “assured image”, which refers to image data that has been processed so that (1) any tampering with the image data can be detected, (2) the image quality of the image data has been measured and the image quality metrics have been secured, and (3) the image quality metrics are linked to the image data so that any changes to the image data render the image quality metrics as invalid. The secure assurance of all images, regardless of whether their image quality meets predetermined quality specifications, provides increased utility as compared to the assurance of images only when the quality is found to be sufficient, as was the case in the method by McComb.

The methods disclosed by Honsinger et al. for forming secure assurance data are: (i) encrypting the quality metrics and a hash of the image data, as described previously for the method by McComb, or (ii) encrypting a hash value of the combination of the quality metrics and the image data. The secure assurance data is then associated with the image data by placing the secure assurance data in an image header, filename, or other means to form an assured image, as mentioned previously. The image data and quality metrics can be authenticated at any time using the methods disclosed by Honsinger et al.

When image data is transferred between a sender and receiver, the formation of an assured image from the transferred image data is beneficial to both the sender and the receiver because it provides evidence of the image quality of the transferred image data, while also securing the image data against any future tampering. However, neither of the previously described methods for producing an assured image provides a convenient and efficient way for the sender and receiver to know that image data was transferred successfully and what image quality was determined for the transferred image data.

In the method by McComb and the method by Honsinger et al., it is disclosed that a user of an assured image formation process is alerted only if quality is found to be insufficient for an intended application. This type of feedback is inadequate in situations when it is desired to inform either the sender or receiver (or both) that image data was transferred successfully, and that the quality of the image data was assessed according to quality specifications. In addition, as disclosed in the method by Honsinger et al., image data may be for multiple image regions, where each region may have different quality metrics and quality specifications associated with it. It may be the case that some image regions have sufficient quality, while other regions have insufficient quality. In this case, a simple user alert that quality is insufficient for an image is again inadequate to convey such quality assessments.

Thus, there is a need for a method to (i) measure the image quality of image data that has been transferred between a sending entity and a receiving entity; (ii) secure the image quality measures and the image data against tampering, while also linking the quality measures and image data so that any changes in the image data will render the image quality measures as invalid; and (iii) provide information to the sending entity and/or the receiving entity regarding the image quality of transferred image data.

### SUMMARY OF THE INVENTION

The present invention is directed to overcoming one or more of the problems set forth above. Briefly summarized, according to one embodiment of the present invention, a method is disclosed for producing an assured image from image data that is transferred from a first entity to a second entity comprising:
a) acquiring image data;
b) transferring the acquired image data from the first entity to the second entity;
c) forming secure assurance data according to image quality measurements obtained from the acquired image data;
d) forming an assured image that comprises the acquired image data and the secure assurance data;
e) generating at least one image quality message that indicates the transfer of the acquired image data from the first entity to the second entity and is representative of the acquired image quality measurements; and
f) providing the at least one image quality message to at least one of the first entity and the second entity.

### ADVANTAGEOUS EFFECT OF THE INVENTION

It is an advantage of the method of the present invention that it computes image quality data from digital image data that is transferred between two entities, wherein the quality data is secured so that it can be verified at any time.

It is another advantage of the method of the present invention that the image data is secured so that the integrity of the digital image can be verified to detect tampering.

It is another advantage of the present invention that an image quality message is formed from the quality data to inform the entities that the image data was transferred successfully and that the quality of the image data was assessed for its intended application.

These and other aspects, objects, features, and advantages of the present invention will be more clearly understood and appreciated from a review of the following detailed description of the preferred embodiments and appended claims, and by reference to the accompanying drawings.

### BRIEF DESCRIPTION OF THE DRAWINGS

FIG. 1 is a block diagram overview of the formation of an assured image and image quality messages for image data that is transferred between two entities using a first embodiment of the present invention.

FIG. 2 is a block diagram overview of the formation of an assured image and image quality messages for image data that is transferred between two entities using a second embodiment of the present invention.

FIG. 3 is a block diagram showing an assurance process of the present invention.

FIG. 4 is an example of spatial regions in a compound document image.

FIG. 5 is an example of spatial regions in a bank check image.

FIG. 6 is an example of spatial regions in a voting ballot image that contains a test target.

FIG. 7 illustrates an example of the formation and use of an image quality message for fax image transfer in the present invention.

FIG. 8 illustrates an example of the formation and use of an image quality message for optical scan voting machines in the present invention.

FIG. 9 is a block diagram showing the use of an image quality message to calculate the payment to be rendered to a digital image service provider in accordance with a business agreement with a customer.

### DETAILED DESCRIPTION OF THE INVENTION

In the disclosure that follows, elements not specifically shown or described may take various forms well known to those skilled in the art.

The invention is directed to forming a digital file from image data generated by digitization of a physical medium or a physical scene. The physical media may, for example, include any of various types of written, printed, or imaged records such as bank checks, X-ray film, photographic film, historical letters, scholarly papers, photographs, income tax forms, paper voting ballots, and book or periodical pages, for example. Physical scenes include any physical entity or entities, such as people, places, and objects, for example, that have been imaged by an image capture device. Embodiments of the present invention encompass image data from any type of digital image capture device. Some types of image capture devices, such as scanners, pass physical media over one-dimensional (1-D) line sensors to construct a two-dimensional (2-D) image data representation. Other imaging devices, such as digital cameras, use a 2-D sensor to directly produce a 2-D image data representation of a physical media or scene. The image data may also include a sequence of digital images, such as those produced by a video camera, where each frame of the image sequence is treated as a separate image for the purpose of the present invention.

The terms “quality metric” and “quality measure” as used herein are interchangeable and describe some measurable characteristic of image quality that can be obtained from analysis of the digital image data. Thus, a quality metric or quality measure can be a characteristic such as dynamic range, brightness, noise, entropy, or other parameter that can be detected and measured using any of a number of techniques that are familiar to those skilled in the image analysis arts.

The present invention includes a method for making an assured image using image data that has been transferred between a sending entity and a receiving entity. As described in the background section, the term “assured image” means that (1) any tampering with the image data can be detected and (2) the image quality of the image data has been assessed and secured against tampering, and (3) the assessed image quality is linked to the secure image data so that any changes to the image data render the assessed image quality as invalid. The terms “sending entity” and “receiving entity” can refer to people, physical devices, or computer processes, either acting separately or in combination to effect the transfer of image data.

An assured image is comprised of image data acquired from a scanner or other digital imaging source and secure assurance data that includes image quality data that has been calculated from the image data that has been acquired. The secure assurance data is representative of both the image data and the image quality data and has been secured against tampering in such a way that any changes in the image data will render the image quality data as invalid.

Image quality data in secure assurance data may include various quality metrics and may further include assigned quality classes that are determined from the quality metrics. The distinction between quality metrics and quality classes is that quality metrics represent measurable properties of the image data, while quality classes describe the suitability of the image data for its intended applications. The quality classes are determined from predetermined quality specifications, such as comparing the quality metrics against quality specification thresholds to determine if quality is “sufficient” or “insufficient”, for example. In this example, there are only two quality classes, but more generally, it is possible to define any number of quality classes such as “excellent”, “good”, “fair”, “poor”, or “unacceptable” or even a wide range of numerical values (for example, an integer number between 0 and 100). The meaning of these quality classes is predefined and depends upon the application. The classification of quality metrics into these non-binary quality classes can be performed by using quality specifications that include multiple quality thresholds, for example. Other methods for determining the quality classes are possible within the scope of the present invention.

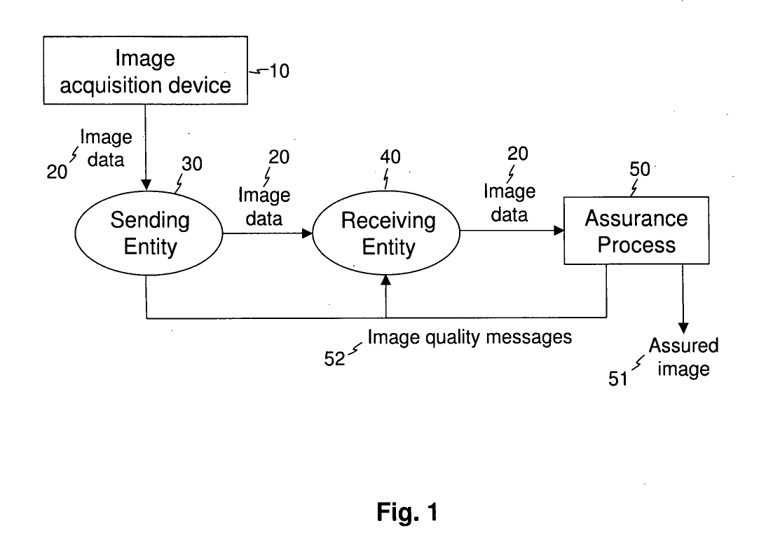

Referring to FIG. 1, a first embodiment for forming an assured image using the present invention is shown for image data that is transferred between two entities. A sending entity 30 uses a digital image acquisition device 10 to acquire image data 20 that is representative of a physical medium or scene. Image data 20 is then transferred from sending entity 30 to a receiving entity 40. Assurance process 50 receives the acquired image data 20 from receiving entity 40 and produces an assured image 51, which can then be used, for example, in myriad image processing applications or stored in a database for future access by receiving entity 40. Assurance process 50 also produces one or more image quality messages 52 indicating that the acquired image data 20 was transferred and include further information about the assessed image quality of image data 20. Image quality messages 52 are sent to sending entity 30 and/or receiving entity 40 to inform at least one of the entities that the image data was received and was processed into an assured image. Image quality messages 52 also inform at least one of the entities of the image quality that was measured for image data 20. In this way, the sending entity and/or receiving entity have unequivocal evidence of the transfer of image data and an assessment of its image quality for any intended applications. A detailed description of embodiments and uses of image quality messages will be presented later.

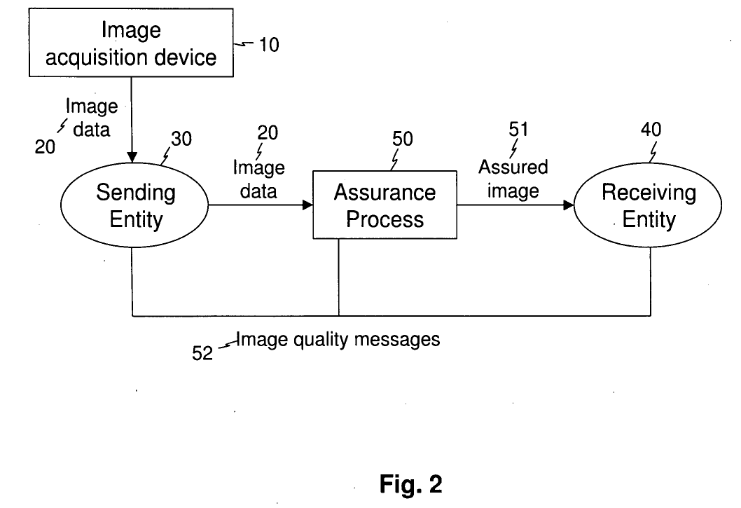

Referring to FIG. 2, a second embodiment for forming an assured image using the present invention is shown for image data that is transferred between two entities. Sending entity 30 uses a digital image acquisition device 10 to capture image data 20 that is representative of a physical medium or scene. Image data 20 is then transferred from sending entity 30 to assurance process 50 to produce assured image 51, and assured image 51 is sent to receiving entity 40. In the same manner as the first embodiment, assurance process 50 in the second embodiment also produces one or more image quality messages 52 that include information about the image quality of image data 20. Image quality messages 52 are sent to sending entity 30 and/or receiving entity 40 to inform at least one of the entities that the image data was received and processed into an assured image, and also to inform at least one of the entities of the image quality that was determined for image data 20.

The embodiments that are illustrated in FIG. 1 and FIG. 2 differ in how image data 20 is provided to assurance process 50. In the first embodiment, receiving entity 40 provides image data 20 as input to assurance process 50. This arrangement may be useful, for example, when receiving entity 40 needs to have full control over the assurance process for various reasons, such as for increased security or when using proprietary image quality metrics. In the second embodiment, sending entity 30 provides image data 20 as input to assurance process 50. This arrangement may useful, for example, when assurance processing is available as a trusted third-party web service over the internet.

Image data 20 that is transferred between sending entity 30 and receiving entity 40 and between receiving entity 40 and assurance process 50 in FIG. 1 (or similarly, between sending entity 30 and assurance process 50 in FIG. 2) is shown being transferred without any security measures to protect the image data against surreptitious tampering or viewing prior to the assurance process. It is understood that various well-known security techniques, such as link encryption and digital signatures, can be applied to the image data during its transfer between sending and receiving entities in order to keep the image data confidential and/or protected from tampering while still remaining within the scope of the present invention. Likewise, image quality messages 52, when they are sent to the sending and receiving entities, may be secured against surreptitious tampering or viewing using similar security measures.

### Image Assurance Process

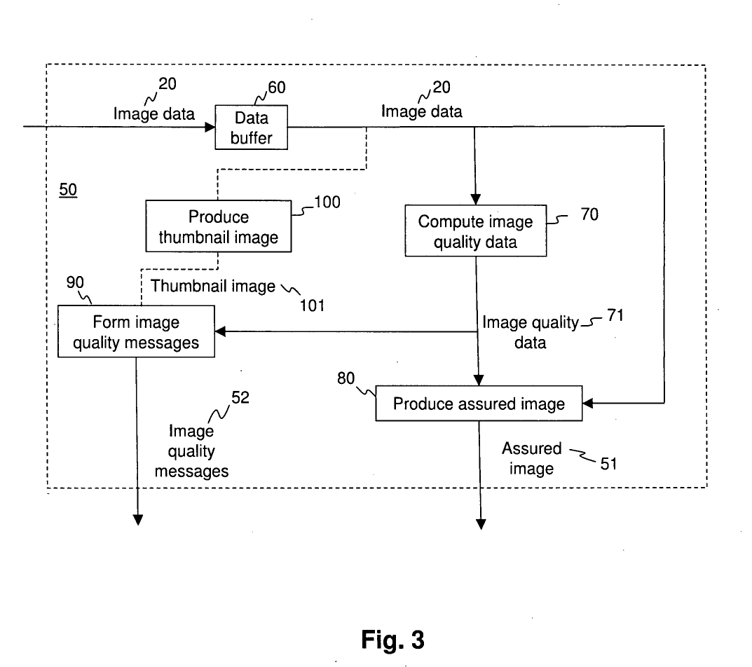

Referring to FIG. 3, an embodiment of assurance process 50 is shown. The following briefly describes the steps in this embodiment, with additional details given subsequently.

Image data 20 is stored in a data buffer 60. This allows image data 20 to be accessed as needed by the components of the assurance process. Image data 20 is sent to an image quality data computation step 70 that computes image quality data 71. Image quality data 71 consists of one or more image quality metrics and one or more assigned quality classes.

Image quality data 71 and image data 20 are sent to an assured image production step 80 to produce an assured image 51. Assured image 51 is associated with secure assurance data that provides the means for securing the image quality data and image data against tampering, while also linking the quality data and image data so that any changes in the image data will render the image quality data as invalid. The secure assurance data and the association of the secure assurance data can be produced using methods that were described earlier in the McComb and Honsinger et al. disclosures.

Image quality data 71 is also sent to an image quality message formation step 90 to produce image quality message 52. Image quality message 52 is a representation of image quality data 71 that is conveniently arranged so that the sending and/or receiving entity can determine if image data 20 was transferred successfully and ascertain what image quality was measured for image data 20 according to its intended applications. As part of the image quality message, it may be advantageous to also include a thumbnail image 101 that is produced by a thumbnail image production step 100 using image data 20 as input. A thumbnail image is a reduced-resolution version of an image that can be efficiently represented for convenient transfer as part of image quality message 52.

### Computation of Image Quality Data

Image quality computation step 70 includes an image segmentation process that identifies spatial regions having characteristics that are of particular relevance for assessing image quality. For example, an image might contain two types of content: text and photographs. The various quality metrics that are determined from the image data, such noise levels, sharpness, and code value histograms, for example, may be quite different for the text and photograph regions of an image. By comparison, an image quality calculation that uses the image data from the entire image may not as readily indicate important changes in image quality. In addition, some quality metrics are not meaningful for certain types of image regions. For example, a sharpness metric may not be relevant for a bi-tonal image.

Some applications can also include a test target with every image that is captured. In such a case, it is necessary to segment the test target region in order to calculate quality metrics that are relevant to the target. Such applications include, for example, using a specially printed form that contains a test target in a designated region, or placing a test target next to an object that is being photographed.

Segmentation can provide any of a number of subsets of the image data, including the full set of image data, encompassing the entire image where necessary. Segmented regions can be spatially overlapping, non-overlapping, contiguous, or not contiguous. Moreover, the union of all segmented regions need not necessarily encompass the entire document. Segmentation can be based upon the characteristics of a region or on specific physical location within the document. Regions may or may not be rectangular.

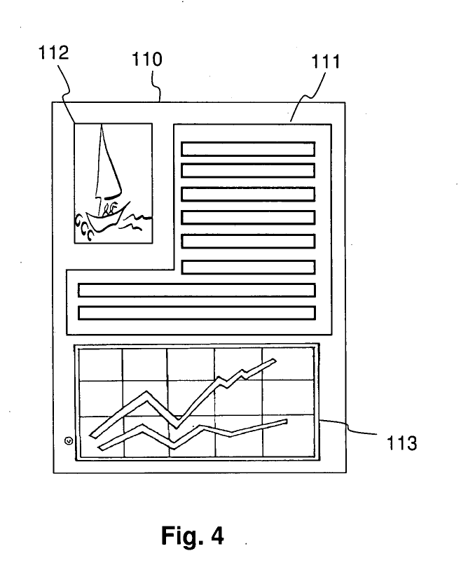

FIG. 4 shows an exemplary compound document image 110 that includes regions of various types. In this example, compound document image 110 includes a text region 111, a photograph region 112, and a graphics region 113. The regions that are used to calculate quality metrics in this example could include the entire document 110 or one or more of the text region 111, the photograph region 112, and/or the graphics region 113, or portions of one or more of these regions.

Automated methods for performing this type of segmentation within compound documents are well known to those skilled in the art. A good example of a technique for performing such segmentation is described in U.S. Pat. No. 5,767,978, by Revankar et al., entitled “Image segmentation system”, issued Jun. 16, 1998. In this patent and in the example of FIG. 4, the segmented regions are based on rectangular blocks of pixels, which is generally a convenient arrangement. However, it is noted that the regions may also have arbitrary shapes that can be determined using any of a wide range of segmentation techniques that have been described in the literature and are familiar to those skilled in the image processing arts.

Another example of a segmentation technique is found in U.S. Pat. No. 6,611,622 by Krumm, entitled “Object recognition system and process for identifying people and objects in an image of a scene”, which teaches a method for isolating people or objects within the frames of a video sequence. Calculating quality metrics, such as sharpness or noise, within the spatial regions that correspond to the people or objects can be beneficial because these elements are typically important in surveillance applications. The segmentation method by Krumm could also be applied to individual still-frame images.

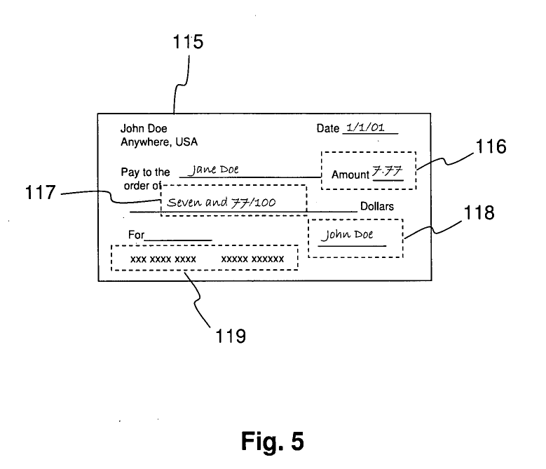

Regions within images may also have fixed or predictable positions. FIG. 5 illustrates an example of a bank check image 115 that includes a convenience amount region 116, a legal amount region 117, a signature region 118, and a MICR (Magnetic Ink Character Recognition) region 119. For this type of document, these regions are largely fixed in position, and the segmentation might be performed by simply specifying coordinates of the regions within the scanned document image. Each of these regions on a bank check may have varying importance to a financial institution, as well as having different characteristics for symbols or characters, such as handwritten characters versus machine characters. Where such differences exist, it may be advantageous to determine the image quality of each region separately, using different quality measures appropriate to the characteristics of the region.

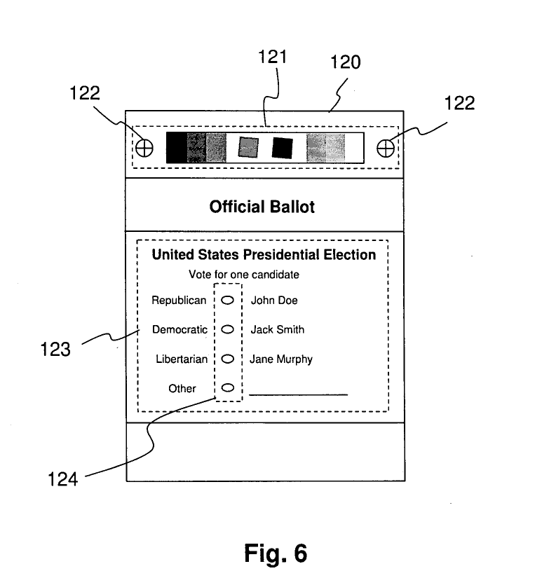

As mentioned previously, the segmented regions can also include image data that represents one or more test targets. FIG. 6 illustrates a voting ballot image 120 that includes a test target region 121. The test target region may be located in a fixed position as previously described, or it may be identified and located using special marks such as fiducials 122. The voting ballot illustrated in FIG. 6 also includes a text region 123 and a voter mark region 124. Voter mark region 124 is filled in by the voter using a pen, pencil, or specialized marking instrument to indicate which candidate is selected. Image quality metrics can also be computed for text region 123 and voter mark region 124.

If the image data does not include any test targets, the image quality metrics that are calculated from segmented image regions are no-reference quality metrics. No-reference quality metrics are typically designed for specific applications, where the nature of the images is constrained, such as the previously described quality metrics for Check 21 applications that use bi-tonal check images. Other examples of no-reference image quality metrics include the following:
(i) dynamic range (for example, computed from maximum image code value—minimum image code value);
(ii) average brightness (for example, computed from the average image code value);
(iii) noise (for example, computed from the code value variance in flat image regions);
(iv) entropy (calculated from the code value histogram); and
(v) color range or relative amount of color (for example, calculated from the code value distribution along color axes).
   Other suitable no-reference metrics could also be used with the present invention. The computation of relevant no-reference image quality metrics is currently an active research area in academia and industry, and the present invention can easily take advantage of any advances in the field.

If a test target is present in the image data, various full-reference quality metrics can be computed. The specific metrics that can be computed depend upon the design of the test target. Some examples of full-reference quality metrics include spatial frequency response, noise, tonescale, color reproduction, color channel misregistration, flare, geometrical distortion, exposure uniformity, dynamic range, and dimensional accuracy. Full-reference quality metrics can also be computed from periodically scanned test targets that are separate from other image content, such as those described in the McComb disclosure referenced earlier.

The quality metrics for a given image may include both full-reference and no-reference quality metrics in various combinations. The quality metrics are then used to assign the segmented image regions into one or more predefined quality classes. The predefined quality classes may vary with the type of image region. For example, a document might include a text region and a continuous-tone photograph region as shown in the example in FIG. 4. A user may want to separately classify each region as having “acceptable” or “unacceptable” quality, because each region will likely have different image quality metrics and perhaps different meanings for the quality classes of “acceptable” and “unacceptable”. However, a user may also desire to provide an overall quality classification for all regions in an image, which can be accomplished by performing a classification process on the combination of all regions with quality classes that have been defined for the entire image. As yet another example, a user might want to classify a single image region according to two different applications, such as whether an amount field in a bank check is “usable” or “not usable” for the purpose of optical character recognition (OCR) and also whether the same amount field is “legible” or “not legible” under human inspection. In this case, two different quality classifications are required for a single image region. The quality class can be computed and stored as part of the secure assurance data for the assured image.

### Image Quality Message Formation

The task of forming an image quality message is now described. Referring again to FIG. 3, image quality data 71, comprising image quality metrics and assigned quality classes, are used to form one or more image quality messages 52 that are sent to the sending entity and/or receiving entity. Image quality message formation step 90 can construct a wide range of message types depending upon the application, and image quality messages 52 can be sent to the entities using any manner of communication devices and communication channels. As mentioned previously, the purpose of an image quality message is to provide feedback to the sending and/or receiving entity that image data 20 was transferred successfully and what image quality was determined for image data 20 according to its intended applications. Furthermore, the image quality messages can include information on actions to be taken if one or more quality problems are associated with image data 20. The following description provides examples of the construction, delivery, and use of image quality messages, but the scope of the present invention is not restricted to the described examples.

One embodiment of an image quality message is a simple text message that includes the filename of the transferred image data and the assigned image quality class or classes that indicate whether or not the image data has sufficient image quality for the intended application. Additional information can also be included in the text message, such as the time/date of transfer, the number of data bytes that were transferred, and sender and recipient identification, for example. For human interaction, a text message of this type could be sent to the sending and/or receiving entity as a human-discernable message, such as using an email message, a web browser message, a GUI message, a faxed document, a cell phone text message, or an annunciated phone voice message, for example. Alternately, if a sending and/or receiving entity include computer devices or processes, the image quality message may be represented as a computer-readable message using any of numerous data protocols, such as data objects with predefined fields or as XML (Extensible Markup Language) documents, for example, that are easily interpreted by a computer device or process. Image quality messages that are transferred may include different image quality information, in accordance with the needs and preferences of the sending and receiving entities.

Image data 20 that is transferred between two entities may also consist of more than just a single image, for example, multiple frames from a video sequence, a multipage fax document, or a series of still frame images. In such a case, an image quality message could include information about each video frame, document page, or still image so that it is possible to identify which frames, pages, or images have quality problems that need to be addressed.

An image quality message may include hyperlinks that are linked to a database that contains the assured image(s), so that the sending and/or receiving entity can use the hyperlink to view the image(s) and review the associated quality data. For example, if the sending entity has transferred a fax image using a telephone connection, the assurance process can send a URL to the sending and/or receiving entity that links to an image quality message file that is available at an internet address. For convenience, the URL could be specified, for example, as an http: address in the form of www.ReceivingEntity.com/555-123-4567.html, where “555-123-4567” is the phone number of the sending entity's fax machine. By selecting this URL, for example, a user or computer process associated with the sending or receiving entity can access the corresponding assured image and its quality data or secure assurance data. Image data that is displayed in a web browser could include an assured image at full-resolution, or a thumbnail image could be provide as a proxy for a full-resolution image, as described below.

As shown in FIG. 3, image quality message 52 can also include a thumbnail image of the received image data. Thumbnail image 101 is a reduced resolution version of the image data 20, and the thumbnail image can be transmitted efficiently and viewed on a variety of display devices including, for example, a computer monitor, a cell phone display panel, or a display panel on a scanner or fax machine. The thumbnail image provides a viewer with simple visual feedback for the image data that was transferred. In addition, it can be marked or in some way annotated with graphical information to provide the sending and/or receiving entity with a quick assessment of the assessed image quality. For example, a compound document image, such as the one shown in FIG. 4, could be used to form a thumbnail image that has the text, photograph, and graphics regions marked or annotated with a color or color outline that indicates the suitability of the image data in each region for the intended application. For example, if the text region has acceptable image quality, it might be annotated with a green border that surrounds the region. Similarly, if the image quality of the photograph region is unacceptable, it could be annotated with a red border. In the case of image sequences or multipage documents, an image quality message could include multiple thumbnails on a single page, with graphical annotations or other markings that indicate image(s) or regions that have quality problems.

### Image Quality Message Example for Fax Image Transfer

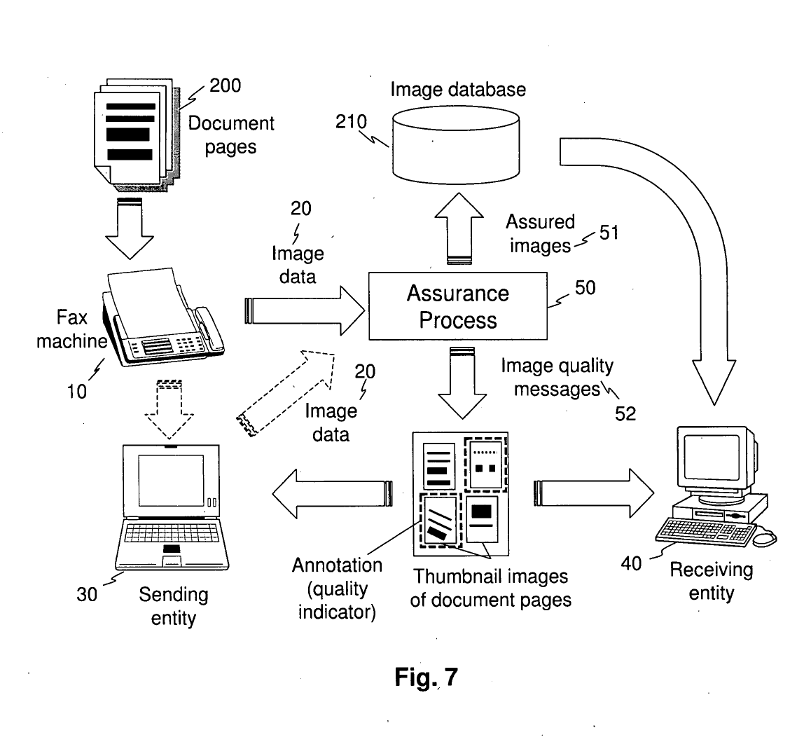

An illustrated example of the use of an image quality message is shown in FIG. 7, using the embodiment of the present invention that was previously described and shown in FIG. 2. In this example, a multipage document 200 is scanned using a fax machine as image acquisition device 10. Image data 20 is produced by the fax machine and is sent by sending entity 30 to assurance process 50 via telephone or network connection. As shown in FIG. 7, sending entity 30 may first receive image data from the fax machine at a local computer and then forward it on to assurance process 50. However, more typically, a fax machine would transfer image data directly to the assurance process, thus serving as the image acquisition device and as the sending entity, in conjunction with the person operating the fax machine.

Assurance process 50 produces assured images 51 that represent the document pages, which are then stored in an image database 210 in this example. Assurance process 50 also produces image quality message 52, which consists of thumbnail images in a 4-up format in this example, with one thumbnail image for each transferred document page. If the image quality that is associated with a document page indicates a problem, such as “unacceptable” image quality, the corresponding thumbnail image is annotated to indicate that there is a quality problem. In this example, the annotation is an identifying border of dashed lines. Image quality message 52 is sent to sending entity 30 and receiving entity 40, where a viewer can review the thumbnail images on a computer monitor and immediately identify any document pages that have an image quality problem. Assured images 51 are also available to receiving entity 40 at any time by accessing image database 210.

The image quality message can also include information on response actions that can be taken to correct one or more image quality problems. For example, continuing the example of FIG. 7, the image quality message may include instructions to rescan and resend those document pages that have image quality problems. The image quality message may also contain recommendations on appropriate equipment settings to improve quality, such as using “fine” mode instead of “standard” mode on a fax machine, for example.

As another example, a document may have a signature section that must be filled in by the sending entity before the document becomes a legally binding agreement. The quality assessment that is performed within the assurance process can segment the signature region and detect whether or not a signature is present. If there is no signature, the image quality message can contain instructions to the sending entity to fill in the signature region and resend the modified document. If a thumbnail image of the document is included in the image quality message, the signature region on the thumbnail image can be graphically highlighted or annotated to indicate the need for a signature.

### Image Quality Message Example for Optical Scan Voting Machines

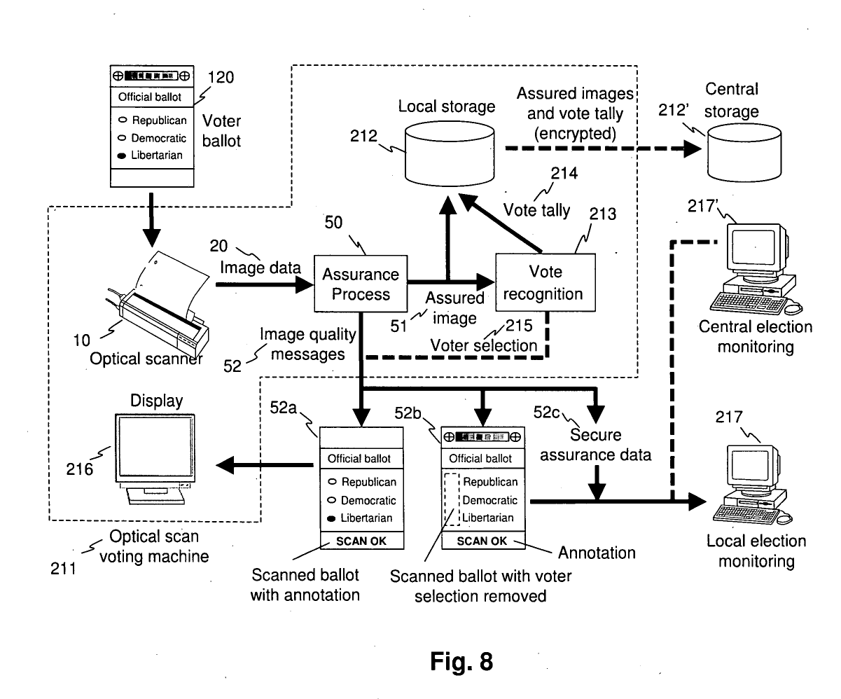

Another example of the use of image quality messages is illustrated in FIG. 8 for optical scan voting system 211, which includes components illustrated within the dashed lines. The dashed lines also represent a secure environment, which means that voting system 211 includes various safeguards, both physical and logical processes, to prevent tampering with data and equipment within the secure environment.

In an optical scan voting system, a voter selects candidates by placing marks on voting ballot 120 in specified locations. In the example in FIG. 8, the voter has selected the “Libertarian” candidate by filling in an oval next to the candidate's name. The voter then places the marked ballot into optical scanner 10 to produce image data 20. Image data 20 is sent to assurance process 50, which produces assured image 51. In this example, the voter acts as a sending entity, operating in conjunction with the internal processes of the voting system, to transfer image data to assurance process 50. It is desirable to produce an assured image immediately after the scanned data is produced as a means of assessing the quality of the scanned data and securing both the quality assessment and the image data against tampering.

Assured image 51 is then sent to a vote recognition step 213, which analyzes assured image 51 to determine which candidate(s) has been selected by the voter. A vote tally 214 is updated to reflect a voter selection 215. Vote tally 214 and assured image 51 are both sent to a local storage 212 that is contained within the secure environment of voting system 211. Assured image 51 and voting tally 214 may also be sent to central storage 212′, and this combined data would typically be encrypted prior to being sent to protect it from surreptitious tampering or viewing when the data is transferred outside of the secure environment. As noted previously, an assured image already includes secure assurance data that allows for any tampering to be detected, but the highly confidential and important nature of voting requires additional security elements to protect all elements within the voting process.

Assurance process 50 also produces one or more image quality messages 52. FIG. 8 illustrates several examples of image quality messages that might be formed for a voting machine application. To provide feedback to the voter, an image quality message 52a can be used, and it consists of the scanned voter ballot image with annotation to indicate whether or not the scanned image quality was sufficient. The scanned ballot image may be further annotated to include voter selection 215 that was determined by vote recognition step 213. In this way, a voter may see the actual scanned ballot using a display 216 to determine if any marks were properly interpreted.

An image quality message 52b is another representation of a scanned ballot, which can be used by election officials for monitoring purposes. In this quality message, the voter selection region is removed, blacked out, or otherwise obscured to prevent election officials from seeing the actual vote that was selected by a voter. However, the rest of the scanned ballot image is available for review to detect any problems with the scanner or with the ballot itself. Image quality message 52b may also contain various annotations to indicate whether or not the quality was sufficient and which regions, if any, have quality problems. Image quality message 52b may be sent to local election monitoring 217 and/or central election monitoring 217′, which can include election officials who view the image quality messages, as well as computer processes that analyze and act upon the quality messages. In this example, the local or central election monitoring personnel and processes act as the receiving entity, in conjunction with the local or central storage that receives assured images.

An image quality message 52c is another example of the type of message that can be used for quality monitoring. This represents the secure assurance data, which includes the quality metrics for assured image 51. The quality metrics can be evaluated by election officials or computer processes for any problems so that appropriate actions may be taken. Image quality message 52c can be used in conjunction with another image quality message, such as image quality message 52b, to provide image quality feedback in several different forms to election officials.

### Image Quality Message Example for Digitization Service Provider

Another benefit of the use of image quality messages with assured images is that the quality messages can be used to efficiently determine a structured payment for services in a business relationship between a digital image service provider and a customer. For example, a customer may contract with a company that digitizes documents in order to convert the customer's existing paper documents into digital image records. This conversion process may involve a large number of documents and high-speed scanners, and it is impractical to have human review of each digitized document for image quality. Thus, the customer would typically have no means for verifying that the documents were digitized properly, and may be paying for services that did not meet the part of the contractual agreement that specifies a quality level for the digitized documents. The quality assessment process of the present invention provides the customer with an automated and secure means for determining the quality of each digitized document, which can then be used to determine a structured payment to the digital image service provider.

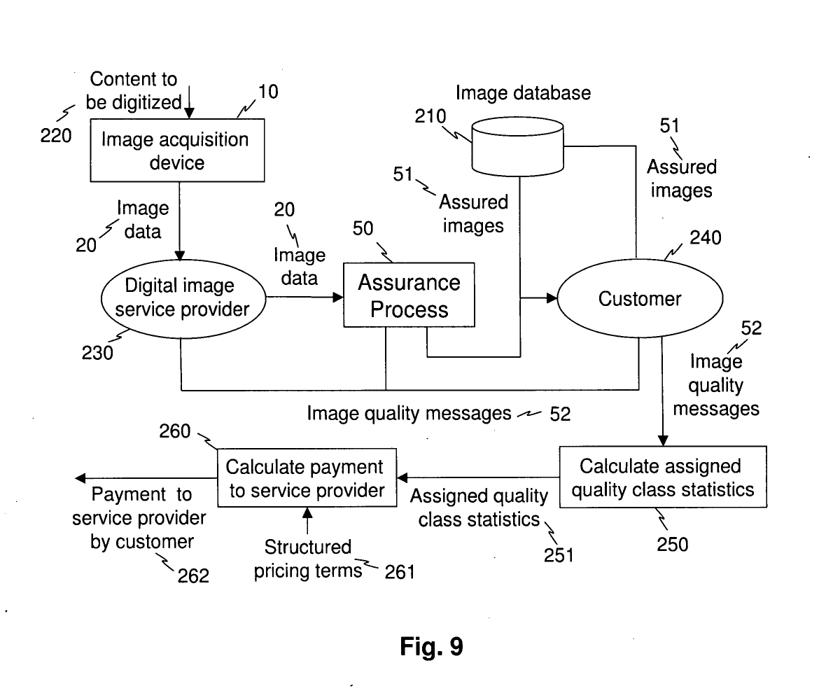

Referring to FIG. 9, a digital image service provider 230 and a customer 240 form a contractual agreement or other business relationship that establishes a set of structured pricing terms 261. The structured pricing terms specify the price that the customer will pay the service provider to digitize a piece of content (such as a document, for example) to a given level of image quality, where the quality for each image is specified by an assigned quality class that is taken from a set of predefined quality classes. Customer 240 provides content to be digitized 220 to digital image service provider 230, who produces image data 20 in a digitization step using a image acquisition device 10. Image data 20 is used to produce a plurality of assured images 51 using assurance process 50. Assured images can be sent to image database 210 for archiving and subsequent access by customer 240, or could be accessed immediately by customer 240 for use in current workflows. In this example, the digital image service provider serves the role of the sending entity and the customer serves the role of the receiving entity in the present invention.

Assurance process 50 also outputs one or more image quality messages 52 that include information on the assessed quality classes for assured images 51. Image quality messages can be directed to customer 240, as well as digital image service provider 230. To determine the value of an assured image and the corresponding payment to be made to the digital image service provider by the customer, customer 240 forwards image quality messages 52 to an assigned quality class statistics calculation step 250 that computes assigned quality class statistics 251 representing the number of images that have been classified into each of the predefined quality classes using the assigned quality classes that are contained in image quality messages 52.

Assigned quality class statistics 251 are then sent to a payment calculation step 260 that uses structured pricing terms 261 and assigned quality class statistics 251 to compute a payment 262 that is to be made to the digital image service provider by the customer based on the value given to the assigned quality classes.

For example, if the contract involves the digitization of 50,000 documents, it may be that 30,000 are classified as having excellent quality, 10,000 as good quality, 5000 as fair quality, 2000 as poor quality, and 3000 as unacceptable quality, where these quality classes and the corresponding quality specifications have been predefined and agreed to by both the service provider and the customer. In this example, the contractual agreement between the two parties previously defined that excellent quality documents have a cost to the customer of $0.07 per document, good quality is $0.05 per document, fair quality is $0.03 per document, poor quality is $0.01 per documents, and unacceptable quality is −$0.02 (that is, the customer gets a $0.02 rebate for each unacceptable document). Thus the total payment from the customer to the provider can be calculated as (30,000×$0.07)+(10,000×$0.05)+(5,000×$0.03)+(2000×$0.01)−(3000×$0.02)=$2710.00. In this way, the image quality messages allow a customer to easily calculate and verify the number of images in each quality class to determine the image quality that was delivered by the digital image service provider. Based on this information, a monetary value can be determined for the digitized images.

In the preceding example, only a single quality class was assigned to each image. However, the present invention easily enables more complex pricing structures, where there may be separate prices associated with the quality of text and photographic regions if compound documents are being scanned, for example. Moreover, the pricing structure could also involve individual quality metrics in addition to the assigned quality classes. Regardless of the complexity of the pricing structure, the secure quality measures and secure assigned quality classes can be used to provide the means for a customer to assess with confidence the quality performance of the digitization services that were provided and to determine a monetary value for each digitized image.

In this example of the use of image quality messages, it is assumed that assurance process is managed by a trusted site so that the image quality messages are not surreptitiously changed by the digital image service provider or other parties. As mentioned previously, link encryption and/or digital signatures can be used to ensure that the image quality messages are not altered between the assurance process and the customer. If increased security is desired, it is possible to move the assurance process under the direct control of the customer, as shown in FIG. 1 and described previously, with the same benefits in determining a structured payment between the service provider and the customer. In addition, the customer can always access the secure quality data that is associated with assured images 51 to verify the quality information that is contained in image quality messages 52.

It will be understood that a computer program product that provides the present invention may make use of image manipulation algorithms and processes that are well known. Thus, it will be understood that a computer program product embodiment of the present invention may embody algorithms, routines, and processes not specifically shown or described herein, such as are useful for implementation. Such algorithms, routines, and processes can be conventional and within the ordinary skill in such arts. Other aspects of such algorithms and systems, and hardware and/or software for producing and otherwise processing the images involved or co-operating with the computer program product of the present invention, may not be specifically shown or described herein and may be selected from such algorithms, systems, hardware, components, and elements known in the art.

The computer program for performing the method of the present invention may be stored in a computer readable storage medium. This medium may comprise, for example: magnetic storage media such as a magnetic disk (such as a hard drive or a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program. The computer program for performing the method of the present invention may also be stored on computer readable storage medium that is connected to the image processor by way of the Internet or other networked communication medium. Those skilled in the art will readily recognize that the equivalent of such a computer program product may also be constructed in hardware or firmware known as application specific integrated circuits (ASICs) or as programmable digital logic chips, such as field programmable gate arrays (FPGAs).

The invention has been described in detail with particular reference to certain preferred embodiments thereof, but it will be understood that variations and modifications can be effected within the spirit and scope of the invention.

### PARTS LIST

10 Image acquisition device
20 Image data
30 Sending entity
40 Receiving entity
50 Assurance process
51 Assured image
52 Image quality messages
52a,52b,52c Example image quality messages for optical scan voting machine
60 Data buffer
70 Image quality data computation step
71 Image quality data
80 Assured image production step
90 Image quality message formation step
100 Thumbnail image production step
101 Thumbnail image
110 Compound document image
111 Text region
112 Photograph region
113 Graphics region
115 Bank check image
116 Convenience amount region
117 Legal amount region
118 Signature region
119 MICR region
120 Voting ballot image
121 Test target region
122 Fiducials
123 Text region
124 Voter mark region
200 Document pages
210 Image database
211 Optical scan voting machine
212 Local storage
212′ Central storage
213 Vote recognition step
214 Vote tally
215 Voter selection
216 Display
217 Local election monitoring
217′ Central election monitoring
220 Content to be digitized
230 Digital image service provider
240 Customer
250 Assigned quality class statistics calculation step
251 Assigned quality class statistics
260 Payment calculation step
261 Structured pricing terms
262 Payment to service provider by customer

1. A method for producing an assured image from image data that is transferred from a first entity to a second entity, comprising the steps of:
a) acquiring image data;
b) transferring the acquired image data from the first entity to the second entity;
c) forming secure assurance data according to image quality measurements obtained from the acquired image data;
d) forming an assured image that comprises the acquired image data and the secure assurance data;
e) generating at least one image quality message that indicates the transfer of the acquired image data from the first entity to the second entity and is representative of the image quality measurements; and
f) providing the at least one image quality message to at least one of the first entity and the second entity.

2. The method of claim 1 wherein generating one or more image quality messages comprises generating a human-discernable message.

3. The method of claim 1 wherein generating one or more image quality messages comprises generating a computer-readable message.

4. The method of claim 1, further comprising repeating steps a) through f) if the least one image quality message includes at least one instance of unacceptable image quality for the acquired image data.

5. The method of claim 1, wherein the at least one image quality message further includes one or more reduced-resolution image representations that are derived from the acquired image data.

6. The method of claim 5, wherein the one or more reduced-resolution image representations are marked to indicate the image quality of one or more regions within the acquired image data.

7. The method of claim 1 wherein generating at least one image quality message further comprises providing a network address that links to at least one of the assured image; a proxy of the assured image; the image quality data; and the secure assurance data.

8. The method of claim 1 wherein forming the assured image comprises obtaining image quality data from a test target.

9. The method of claim 1 wherein forming the assured image further comprises encrypting at least one of the acquired image data and the secure assurance data.

10. The method of claim 1 further comprising computing a monetary value for the acquired image data using information contained in the secure assurance data.

11. The method of claim 1 wherein the acquired mage data represents a voter ballot containing a voter selection region and the image quality message includes a representation of the acquired image data with the voter selection region obscured.

12. A method for producing an assured image from image data that is transferred from a first entity to a second entity, comprising the steps of:
a) acquiring image data;
b) forming secure assurance data according to image quality measurements obtained from the acquired image data;
c) forming an assured image that comprises the acquired image data and the secure assurance data;
d) transferring the assured image from the first entity to the second entity;
e) generating at least one image quality message that indicates the transfer of the assured image from the first entity to the second entity and is representative of the image quality measurements; and
f) providing the at least one image quality message to at least one of the first entity and the second entity.

13. The method of claim 12 wherein generating one or more image quality messages comprises generating a human-discernable message.

14. The method of claim 12 wherein generating one or more image quality messages comprises generating a computer-readable message.

15. The method of claim 12, further comprising repeating steps a) through f) if the image quality message includes at least one instance of unacceptable image quality for the acquired image data.

16. The method of claim 12, wherein the at least one image quality message further includes one or more reduced-resolution image representations that are derived from the acquired image data.

17. The method of claim 16, wherein the one or more reduced-resolution image representations are marked to indicate the image quality of one or more regions within the acquired image data.

18. The method of claim 12 wherein generating at least one image quality message further comprises providing a network address that links to at least one of the assured image; a proxy of the assured image; the image quality data; and the secure assurance data.

19. The method of claim 12 wherein forming the assured image further comprises encrypting at least one of the acquired image data and the secure assurance data.

20. The method of claim 12 wherein forming the assured image comprises obtaining image quality data from a test target.

21. The method of claim 12 further comprising computing a monetary value for the acquired image data using information contained in the secure assurance data.

22. The method of claim 12 wherein the acquired mage data represents a voter ballot containing a voter selection region and the image quality message includes a representation of the acquired image data with the voter selection region obscured.
